(19) United States
(12) Patent Application Publication
(10) Pub. No.: US 2008/0025014 A1
(43) Pub. Date: Jan. 31, 2008

(54) Adjusting structure of a laser indicator of a sawing machine

(76) Inventor: Hsin-Chin Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/492,865

(22) Filed: Jul. 26, 2006

(51) Int. Cl. F21V 33/00; G02B 27/20

(52) U.S. Cl. 362/89; 362/259

(57) ABSTRACT

A laser indicator is secured on a rotating shaft of a sawing machine, on which rotating shaft a saw is fitted; the laser indicator consists of a housing member, a laser module, and an adjusting mechanism; the housing member has a locating recess on an inner side thereof, and the laser module is held in the locating recess; the adjusting mechanism is arranged on a front portion of the laser module; thus, orientation of the laser module can be adjusted to make a laser beam from the laser module head towards exactly the same direction as the blade of the saw of the sawing machine by means of using the adjusting mechanism.

### BACKGROUND OF THE INVENTION

1. Field of the invention

The present invention relates to an adjusting structure of a laser indicator of a sawing machine, more particularly one, which allows position of the laser module to be adjusted such that a laser beam emitted from the laser module will head in a correct direction, i.e. towards the same direction as the saw blade of the sawing machine.

2. Brief Description of the Prior Art

Cutting machines and sawing machines are usually equipped with a laser indicator, which emits a laser beam for marking the portion of a work piece to be cut/sawed such that a cutting/sawing process can be carried out accurately.

A conventional laser indicator is fitted on a rotating shaft of a sawing machine, on which a saw is secured. The laser indicator will emit a laser beam heading towards the same direction as the blade of the saw; thus, it is ensured that the saw blade will cut the intended portion of a work piece, which is currently marked by the laser beam, after the rotating shaft starts rotating. In other words, a sawing process can be carried out accurately owing to the laser indicator.

However, the above-mentioned laser indicator has a disadvantage: a laser module of the above-mentioned laser indicator is fixed on a circuit board by means of solder welding therefore the orientation of the laser module can't be adjusted for changing direction of the laser beam even if the laser beam fails to head towards the same direction as the saw blade. Consequently, the whole laser indicator becomes useless, and has to be discarded, resulting in significant undesirable increase in the manufacturing cost.

### SUMMARY OF THE INVENTION

It is a main object of the invention to provide an improvement on a laser indicator of a sawing machine to overcome the above-mentioned problems. The laser indicator is securely fitted on a rotating shaft of a sawing machine, on which rotating shaft a saw is securely fitted. The laser indicator consists of a housing member, a laser module, and an adjusting mechanism. The housing member has a locating recess on an inner side thereof, and the laser module is held in the locating recess. The adjusting mechanism is arranged on a front portion of the laser module; thus, orientation of the laser module can be adjusted to make a laser beam from the laser module head towards exactly the same direction as the blade of the saw of the sawing machine by means of using the adjusting mechanism.

In addition, the laser indicator is equipped with a manual switch for turning on/off the indicator with. And, the laser indicator is equipped with a vibrating switch, which will be automatically moved to “ON” position so as to make the laser indicator emit a laser beam when the rotating shaft of the sawing machine starts rotating.

### BRIEF DESCRIPTION OF THE DRAWINGS

The present invention will be better understood by referring to the accompanying drawings, wherein:

FIG. 1 is an exploded perspective view of the laser indicator of the present invention,

FIG. 2 is a partial view of the present invention,

FIG. 3 is a view of the laser indicator fitted on a sawing machine,

FIG. 4 is a partial view of the laser indicator, taken when the vibrating switch is in the OFF position,

FIG. 5 is a partial view of the laser indicator, taken when the vibrating switch is in the ON position,

FIG. 6 is a partial view of the laser indicator, taken before the laser module is adjusted to the correct position, and

FIG. 7 is a partial view of the laser indicator, taken after the laser module is adjusted to the correct position.

### DETAILED DESCRIPTION OF THE PREFERRED EMBODIMENTS

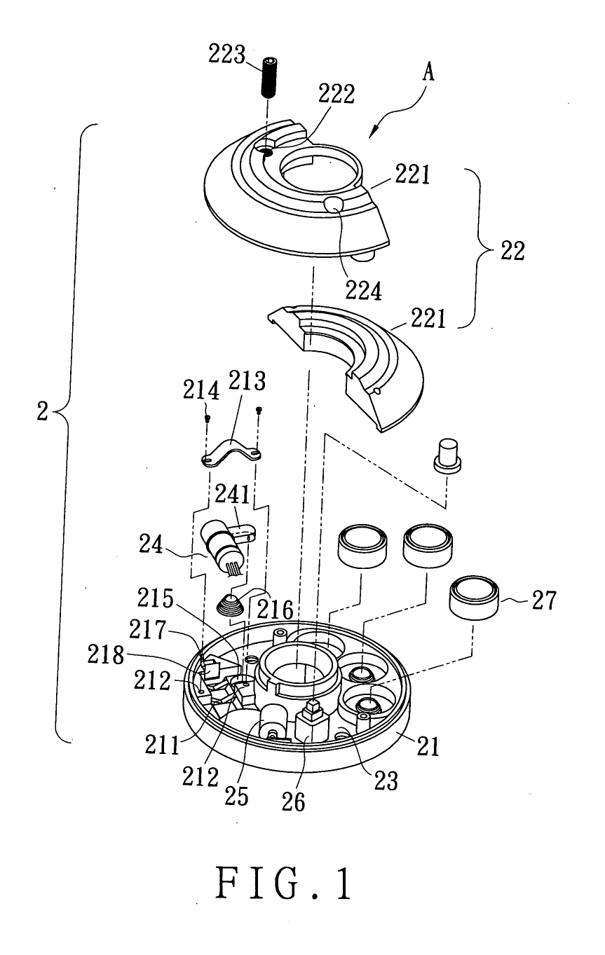

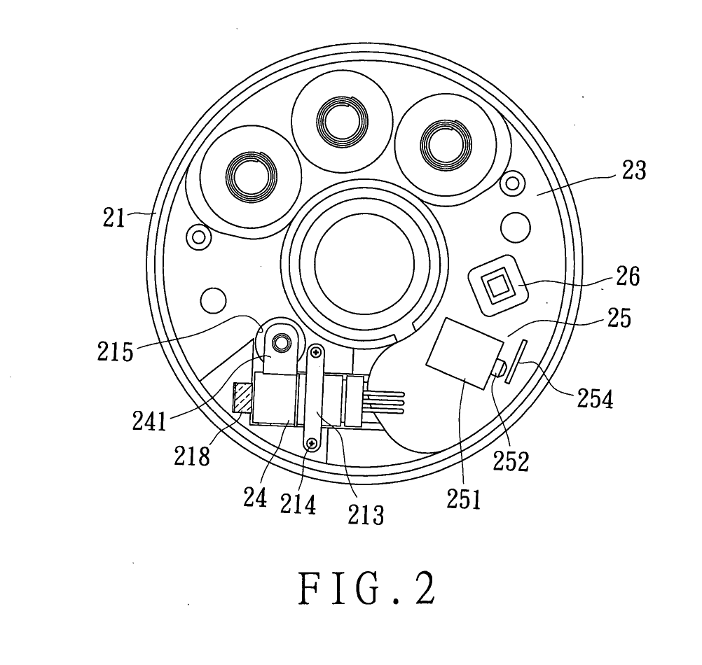

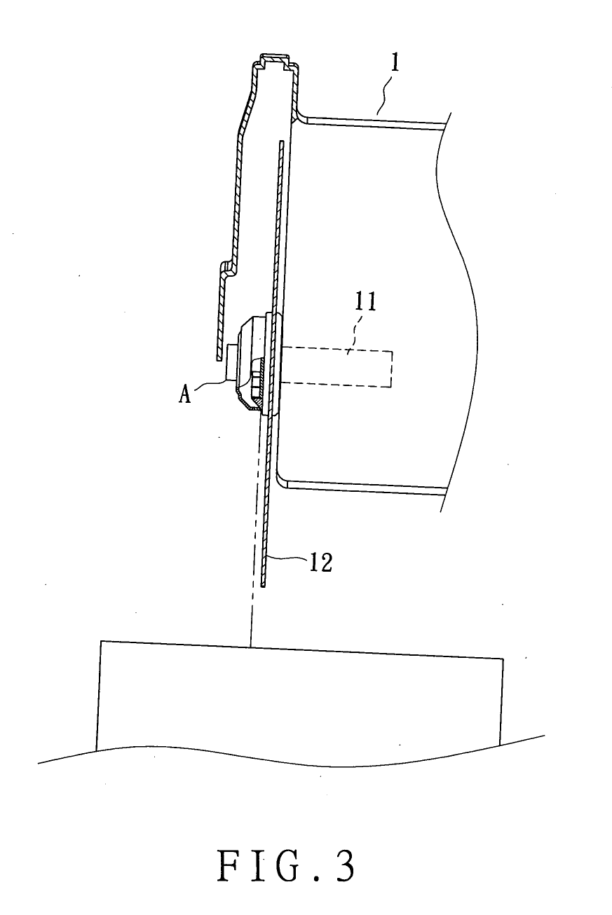

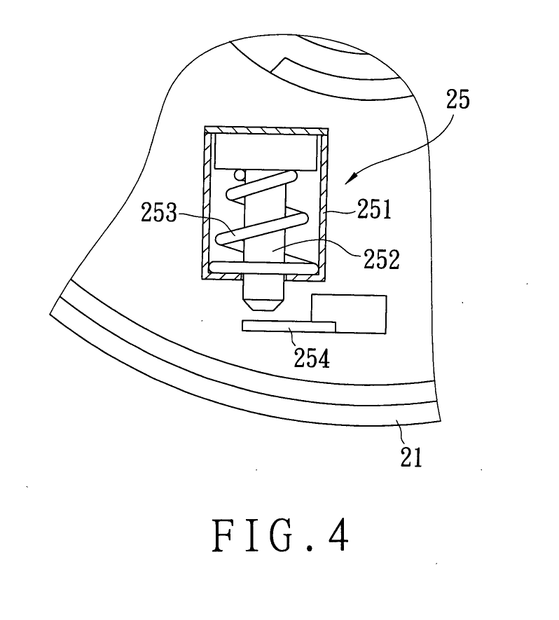

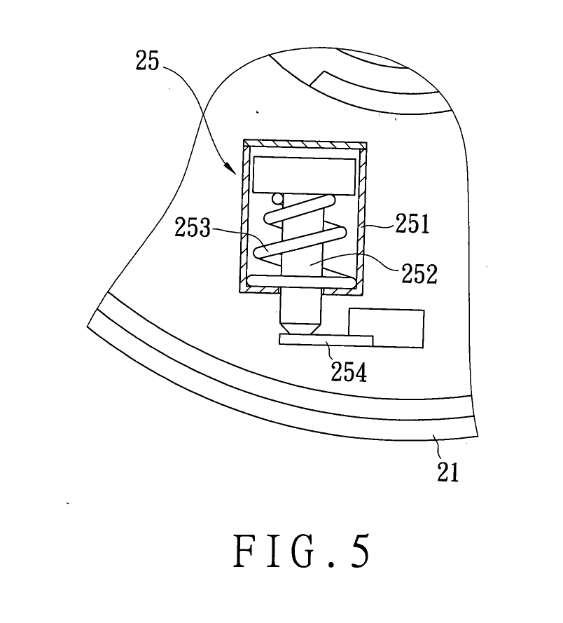

Referring to FIGS. 1 to 7, a preferred embodiment of a laser indicator (A) of the present invention includes a housing member 2, a circuit board 23, a laser module 24, a vibrating switch 25, a manual switch 26, and a battery set 27, which are held in the housing member 2. The laser indicator (A) is securely fitted on a rotating shaft 11 of a sawing machine 1, to which a saw 12 is securely fitted.

The housing member 2 consists of an upper cover 22, and a base 21, which are coupled together. The laser module 24, the vibrating switch 25, the manual switch 26, and the battery set 27 are connected to the circuit board 23 so as to form a circuit. The base 21 has a V-shaped locating recess 211 thereon, connecting holes 212 on two sides of the V-shaped locating recess 211, a receiving cavity 215 therein, and a through hole 217. The laser module 24 is positioned on the V-shaped locating recess 211 of the base 21, and fastened with a fastening piece 213, which is positioned on the laser module 24, and fixed to the base 21 by means of fixing elements 214 passed through the fastening piece 213 and into the connecting holes 217 of the base 21.

The laser module 24 has a protruding portion 241 on a front section thereof, which faces the protruding portion 241 of the laser module 24. And, an elastic element 216 is positioned on the receiving cavity 215 of the base 21 to prop up the protruding portion 241 of the laser module 24. The laser module 24 has an off-center beam producing point, and a laser beam will head towards the through hole 217 of the base 21 when emitted from the laser module 24. Furthermore, a prism 218 is positioned in front of the through hole 217 of the base 21; thus, the laser beam will travel outside through the prism 218 and the through hole 217.

The upper cover 22 consists of first and second covering half parts 221. The first covering half part 221 has an adjustment hole 222, and a through hole 224 thereon. An adjusting element 223 is passed through the adjustment hole 222, and touches the protruding portion 241 of the laser module 24; thus, position of the laser module 24 can be adjusted by means of changing position of the adjusting element 223 in relation to the adjustment hole 222. The manual switch 26 is sticks out through the through hole 224 of the first covering half part 221 of the upper cover 22 such that the user is allowed to press the manual switch 26. The second covering half part 221 covers the battery set 27, and it can be separated from the base 21.

The vibrating switch 25 consists of an electricity-conducting sleeve 251, a touching needle 252 held in the electricity-conducting sleeve 251, a contact point 254 connected to the circuit board 23 and facing a tail end of the touching needle 252, and an elastic element 253, which is joined to the touching needle 252 for biasing the touching needle 252 away from the contact point 254. Thus, when the rotating shaft 11 of the sawing machine 1 is rotating, the touching needle 252 will come into contact with the contact point 254 owing to centrifugal force, to close the circuit consisting of the circuit board 23, the laser module 24, the vibrating switch 25, the manual switch 26, and the battery set 27. Therefore, the circuit can be opened/closed by means of the vibrating switch 25, or alternatively it can be opened/closed by means of the manual switch 26.

FIGS. 1 to 7 show a first preferred embodiment of a laser indicator 1 in the present invention, which is securely fitted on a rotating shaft 21 of a sawing machine 2, and includes a base 11, a circuit board 12, a laser module 13, a vibrating switch 14, a manual switch 15, a covering member 16, a battery set 17, and an elastic piece 19. The sawing machine 2 further has a saw secured on the rotating shaft 21.

The circuit board 12 is secured on the base 11. The laser module 13 is connected to the circuit board 11 while both the vibrating switch 14 and the manual switch 15 are fitted on the circuit board 12. The covering member 16 is positioned over the base 11, and it consists of a front covering part 161, and a rear covering part 162. The front and the rear covering parts 161 and 162 have several fasteners 163, and fastening holes 164 thereon, and they are coupled together with the fasteners 163 being fitted in the fastening holes 164. The battery set 17, are secured to an inner side of the rear covering part 162, and they have connecting legs 171, which touch the circuit board 12 such that the battery set 17, the laser module 13, the vibrating switch 14, and the manual switch 15 together comprise a circuit. The front covering part 161 has a through hole 165 on a circumferential side thereof, which faces the laser module 13 for a laser beam emitted from the laser module 13 to pass through. Furthermore, the front covering part 161 has a through hole 166 facing the manual switch 15.

The laser module 13 is securely fitted on the elastic piece 19, and the elastic piece 19 is secured to the base 11 at one end, and the other end of the elastic piece 19 is free. The front covering part 161 of the covering member 16 has a screw hole 167, and a threaded element 18 is passed through the screw hole 167 and pressed against the elastic piece 19; the position of the laser module 13 can be adjusted by means of turning the threaded element 18 for changing the position of the threaded element 18 in relation to the screw hole 167.

Therefore, when the rotating shaft 11 of the sawing machine 11 starts rotating, the laser indicator (A) will rotate together with the rotating shaft 11, and the vibrating switch 25 will move to the “on” position to close the circuit, with the touching needle 252 thereof being moved so as to touch the contact point 254 by centrifugal force. Consequently, the laser module 24 is powered, and emits a laser beam, which will through the through hole 217 of the base 21, and head towards exactly the same direction as the blade of the saw 12 of the sawing machine 1. Therefore, an intended portion of a work piece will certainly be cut with the saw 12 of the sawing machine 1 if the work piece is placed in such a position that the laser beam travels onto the intended portion of the work piece. In other words, with the help of the laser indicator, the sawing process can be carried out accurately.

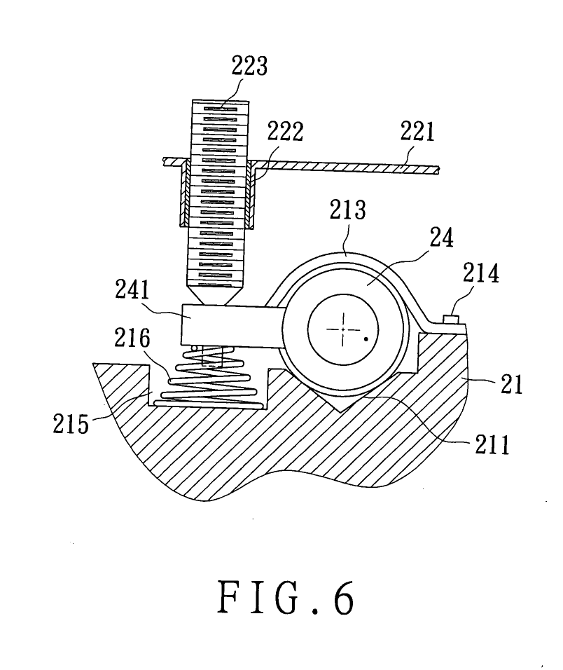

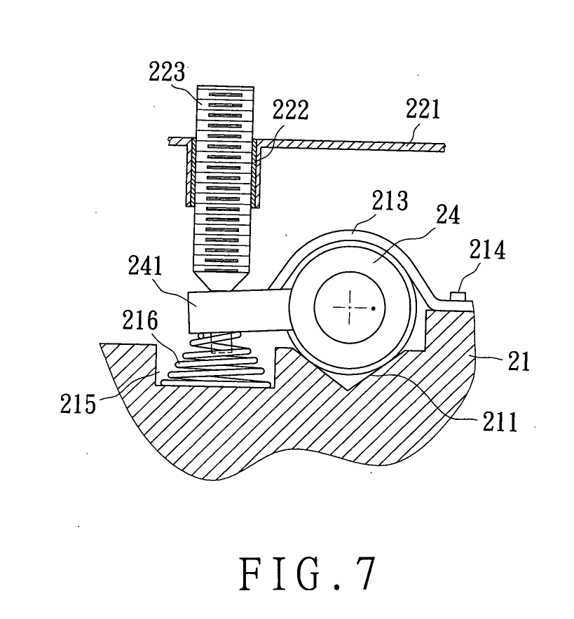

Referring to FIGS. 6 and 7, if the laser beam from the laser module 24 fail to head towards exactly the same direction as the blade of the saw 12 of the sawing machine 1, the user should adjust position of the adjusting element 223 in relation to the adjustment hole 222 so as to make the laser module 24 turn about its axis to a correct orientation, in which orientation the laser beam emitted from the laser module 24 will head towards exactly the same direction as the blade of the saw 12; because the beam producing point of the laser module 24 is off-center, the angular displacement of the laser module 24 will result in orientational change of the beam producing point. Consequently, the direction of the laser beam is adjusted.

After the laser module 24 is adjusted in position, the user is allowed to turn on the laser module 24 by means of pressing the manual switch 26, and check whether the laser beam emitted from the laser module 24 heads towards exactly the same direction as the blade of the saw 12 of the sawing machine 1. In other words, the user is allowed to check whether the laser beam heads towards exactly the same direction as the blade of the saw 12 while the rotating shaft 11 of the sawing machine 1 is still. Therefore, the laser module is relatively convenient to use.

The user is allowed to change the battery set 27 after he separates the second covering half part 221 of the upper cover 22 from the base 21 and the first covering half part 221; after battery change, the second covering half part 221 is coupled back to the base 21 and the first covering half part 221. In other words, it's not necessary for the user to remove the whole upper cover 22; if the whole upper cover 22 were removed for battery change, the user would have to fit the upper cover 22 back to the base 21 carefully, otherwise the various parts of the laser indicator could be in incorrect position in relation to each other.

From the above description, it can be seen that the present invention has the following advantages:

1. Owing to the adjusting structure, the laser module of the laser indicator can be moved to adjust the direction of the laser beam emitted from it such that the laser beam will head towards exactly the same direction as the blade of the saw of the sawing machine.

2. The upper cover of the housing member of the laser indicator consists of two half parts therefore its' not necessary for the user to remove the whole upper cover in battery change, and the laser indicator is relatively convenient to use.

3. The laser indicator of the present invention is equipped with the vibrating switch, which will be moved to “ON” position by centrifugal force only when the sawing machine is working, therefore it is power-saving to use the laser indicator.

4. The laser indicator of the present invention is equipped with the manual switch in addition to the vibrating switch for closing the circuit with therefore the user is allowed to check whether the laser beam emitted from the laser module heads towards the correct direction when the sawing machine is idle.

What is claimed is:

1. An adjusting structure of a laser indicator of a sawing machine,
a laser indicator being securely fitted on a rotating shaft of a sawing machine, to which rotating shaft a saw is securely fitted;
said laser indicator comprising:
a housing member;
a circuit board secured in the housing member;
a laser module and a battery set connected to the circuit board to comprise a circuit; the laser module having a protruding portion; the housing member having a though hole for allowing a laser beam emitted from the laser module to travel through; the housing member having a locating recess on an inner side, in which the laser module is held;
an adjusting element, the adjusting element being coupled to the housing member and touching the protruding portion of the laser module; and
an elastic element, the elastic element being positioned so as to prop the protruding portion of the laser module.

2. The adjusting structure of a laser indicator of a sawing machine as recited in claim 1, wherein the circuit board has a manual switch fitted thereon to comprise a circuit together with the laser module and the battery set, and the housing member has a through hole facing the manual switch.

3. The adjusting structure of a laser indicator of a sawing machine as recited in claim 2, wherein the circuit board has a vibrating switch fitted thereon to comprise a circuit together with the laser module and the battery set; the vibrating switch including an electricity-conducting sleeve, a touching needle held in the electricity-conducting sleeve, a contact point facing a tail end of the touching needle and connected to the circuit board, and an elastic element joined to the touching needle for biasing the touching needle.

4. The adjusting structure of a laser indicator of a sawing machine as recited in claim 1, wherein the locating recess is V-shaped.

5. The adjusting structure of a laser indicator of a sawing machine as recited in claim 1, wherein the base has a connecting hole next to each of two sides of the laser module, and the laser module is fastened with a fastening piece, which is positioned on the laser module, and securely joined to the base with fixing elements being passed through the fastening piece and into the connecting holes of the base.

6. The adjusting structure of a laser indicator of a sawing machine as recited in claim 1, wherein the base has a receiving cavity facing the protruding portion of the laser module, and the elastic element is located in the receiving cavity.

7. The adjusting structure of a laser indicator of a sawing machine as recited in claim 1, wherein the hosing member consists of a base and an upper cover, which are coupled together; the upper cover consisting of two half parts; one of the half parts of the upper cover being arranged over the battery set.
